(19) United States
(12) Patent Application Publication
(10) Pub. No.: US 2025/0254254 A1
(43) Pub. Date: Aug. 7, 2025

(54) IMAGE READING SYSTEM, IMAGE READING DEVICE, AND CONTROL DEVICE

(71) Applicant: SEIKO EPSON CORPORATION, Tokyo (JP)

(72) Inventors: Yuko HIRAYAMA, KITAKYUSHU-SHI (JP); Kenichi MURAHASHI, KITAKYUSHU-SHI (JP)

(21) Appl. No.: 19/040,111

(22) Filed: Jan. 29, 2025

(30) Foreign Application Priority Data
Feb. 1, 2024 (JP) 2024-014291

(51) Int. Cl. H04N 1/00; G06V 30/413

(52) U.S. Cl. CPC H04N 1/00644; G06V 30/413; H04N 1/0049

(57) ABSTRACT

An image reading system includes a transport section that transports documents one by one from a batch of documents, a reading section that reads documents, a display section that displays a setting screen by which a target condition, which is a condition for a document that is to be a reading target, is set, and a control section, wherein the control section counts the number of documents that matches a target condition based on image data of the documents read by the reading section, and cause the display section to display the number of documents that matches the target condition.

The present application is based on, and claims priority from JP Application Serial Number 2024-014291, filed Feb. 1, 2024, the disclosure of which is hereby incorporated by reference herein in its entirety.

### BACKGROUND

### 1. Technical Field

The present disclosure relates to an image reading system, an image reading device, and a control device.

### 2. Related Art

WO2023/067709 describes an image reading device that transports a document from a batch of documents. This image reading device counts the transported documents.

In image reading device, there is a case where documents that the user did not intend to read are mixed in the batch of documents. For example, a document of different size may be mixed in the batch of documents that is to be a reading target. In this case, there is concern that the document to be the reading target may not be counted correctly. Therefore, there is concern that the user cannot correctly grasp the number of documents.

### SUMMARY

In order to overcome the above described concern, an image reading system includes a transport section that transports documents one by one from a batch of documents; a reading section that reads documents; a display section that displays a setting screen by which a target condition, which is a condition for a document that is to be a reading target, is set; and a control section, wherein the control section counts documents that match the target condition based on image data of the documents read by the reading section and causes the display section to display the number of documents that match the target condition.

In order to overcome the above concern, an image reading device includes a transport section that transports documents one by one from a batch of documents; a reading section that reads documents; a display section that displays a setting screen by which a target condition, which is a condition for a document that is to be a reading target, is set; and a control section, wherein the control section counts documents that match the target condition based on image data of the documents read by the reading section and causes the display section to display the number of documents that match the target condition.

In order to overcome the above concern, a control device connected to an image reading device including a transport section that transports documents one by one from a batch of documents and a reading section that reads documents, includes a display section that displays a setting screen by which a target condition, which is a condition for a document that is to be a reading target, is set; and a control section configured to communicate with the image reading device, wherein the control section counts documents that match the target condition based on image data of the documents read by the reading section and causes the display section to display the number of documents that match the target condition.

In order to overcome the above concern, a method for controlling an image reading system including a transport section that transports documents one by one from a batch of documents, a reading section that reads documents, and a display section that displays a setting screen for setting a target condition for a document to be a reading target, includes counting a document that matches the target condition based on image data of the document read by the reading section and causing the display section to display the number of documents that match the target condition.

### BRIEF DESCRIPTION OF THE DRAWINGS

FIG. 1 is a schematic diagram showing an example of an image reading system.

FIG. 2 is a schematic diagram showing a home screen.

FIG. 3 is a schematic diagram showing a setting screen.

FIG. 4 is a schematic diagram showing a blank paper condition screen.

FIG. 5 is a schematic diagram showing the current status screen.

FIG. 6 is a schematic diagram showing a notification screen.

FIG. 7 is a schematic diagram showing a result screen.

FIG. 8 is a flowchart of the count mode.

### DESCRIPTION OF EMBODIMENTS

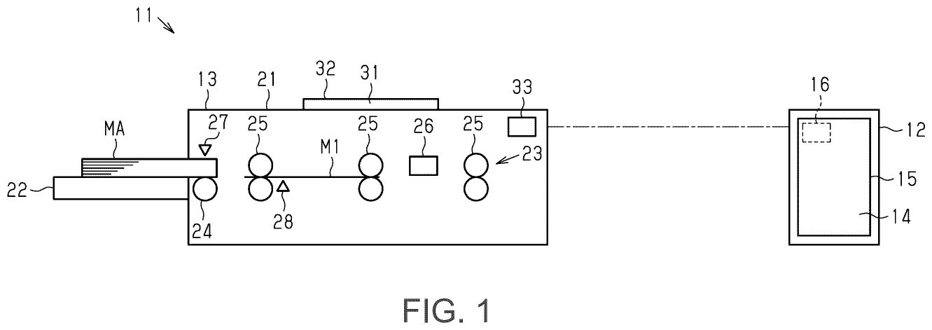

Hereinafter, an embodiment of an image reading system will be described with reference to the drawings. As shown in FIG. 1, an image reading system 11 is equipped with a control device 12 and an image reading device 13. The control device 12 is configured to control the image reading device 13. The control device 12 communicates with the image reading device 13. The control device 12 is connected by wire or wirelessly to the image reading device 13. The control device 12 is, for example, a personal computer, a smartphone, or a tablet. In the image reading system 11, the control device 12 may store a driver that controls the image reading device 13. In the image reading system 11, the image reading device 13 may work independently.

### Control Device

The control device 12 is equipped with an operation section. Specifically, the control device 12 is equipped with a terminal operation section 14. The terminal operation section 14 is operated by the user. The user operates the control device 12 via the terminal operation section 14. The terminal operation section 14 is, for example, a touch panel. The terminal operation section 14 is not limited to a touch panel, and may be a button, a lever, or the like.

The control device 12 is equipped with a display section. Specifically, the control device 12 is equipped with a terminal display section 15. The terminal display section 15 displays a screen. Specifically, the terminal display section 15 displays a screen for operating the image reading device 13. The user gives an instruction to the image reading device 13 via a screen displayed on the terminal display section 15.

The control device 12 is equipped with a control section. Specifically, the control device 12 is equipped with a terminal control section 16. The terminal control section 16 controls the terminal display section 15. The terminal control section 16 controls so as to cause the terminal display section 15 to display a screen. The terminal control section 16 is configured to communicate with the image reading device 13. The terminal control section 16 transmits an instruction input via the screen displayed on the terminal display section 15 to the image reading device 13.

The terminal control section 16 may be configured from one or more processors that perform various processes according to a computer program. The terminal control section 16 may be configured from one or more dedicated hardware circuits such as an ASIC that performs at least a part of various processes. The terminal control section 16 may be configured from a circuit including a combination of a processor and a hardware circuit. The processor includes a CPU and a memory, such as a RAM and a ROM. The memory stores program code or instructions configured to cause the CPU to perform processes. The Memory, that is, a computer-readable medium, includes any readable media that can be accessed by a general-purpose or dedicated computer.

### Image Reading Device

The image reading device 13 is configured to read documents M1. The image reading device 13 is, for example, a scanner that reads images such as a character or a photograph printed on the documents M1 such as a sheet or a film.

The image reading device 13 is equipped with a housing 21. The image reading device 13 is equipped with a supply tray 22. A batch of documents MA, where a plurality of documents M1 are stacked, is set on the supply tray 22. The supply tray 22 extends from the housing 21. The supply tray 22 guides documents M1 into the housing 21.

The image reading device 13 is equipped with a transport section 23. The transport section 23 is configured to transport the documents M1. The transport section 23 transports the documents M1 one by one from the batch of documents MA. The transport section 23 transports the documents M1 on the supply tray 22 into the housing 21. The transport section 23 discharges the documents M1 from inside of the housing 21 to outside of the housing 21.

The transport section 23 has a plurality of rollers. The transport section 23 has a pickup roller 24. The pickup roller 24 is a roller that transports the documents M1 one by one from the batch of documents MA. In one example, the pickup roller 24 comes into contact with a document M1 located at the bottommost of the batch of documents MA. The transport section 23 has one or more transport roller pairs 25. The transport roller pair 25 rotates while sandwiching the document M1. The transport section 23 may have a retard roller that suppresses multi-feed. The multi-feed means that multiple documents M1 are transported in a stacked state. The retard roller, for example, rotates to return the document M1 from the housing 21 to the supply tray 22.

The image reading device 13 is equipped with a reading section 26. The reading section 26 is configured to read the documents M1. The reading section 26 reads the documents M1 to be transported. The reading section 26 is configured with a plurality of optical sensors aligned in a main scanning direction. The reading section 26 is, for example, a contact image sensor module. The reading section 26 generates image data of the document M1 by reading the document M1. The reading section 26 may be configured to read either one surface or both surfaces of the document M1.

The image reading device 13 is equipped with a tray detection section 27. The tray detection section 27 is configured to detect the document M1. Specifically, the tray detection section 27 detects whether or not there is a document M1 that was set on the supply tray 22. In one example, the tray detection section 27 is located so as to face the pickup roller 24. The tray detection section 27 is, for example, configured with an optical sensor.

The image reading device 13 may be equipped with a count detection section 28. The count detection section 28 is configured to detect the document M1. Specifically, the count detection section 28 detects a document M1 that is fed by the pickup roller 24. The image reading device 13 can count the documents M1 using the count detection section 28. In one example, the count detection section 28 is located between the reading section 26 and the pickup roller 24. The count detection section 28 is, for example, configured with an optical sensor.

The image reading device 13 may be equipped with an operation section. For example, the image reading device 13 may be equipped with a reading operation section 31. The reading operation section 31 is operated by the user. The user operates the image reading device 13 via the reading operation section 31. The reading operation section 31 is, for example, a touch panel. The reading operation section 31 is not limited to the touch panel, and may be a button, a lever, or the like.

The image reading device 13 may be equipped with a display section. For example, the image reading device 13 may be equipped with a reading display section 32. The reading display section 32 displays a screen. Specifically, the reading display section 32 displays a screen for operating the image reading device 13. The user gives an instruction to the image reading device 13 via the screen displayed on the reading display section 32.

The image reading device 13 is equipped with a control section. Specifically, the image reading device 13 is equipped with a reading control section 33. The reading control section 33 controls the reading display section 32. The reading control section 33 controls so as to cause the reading display section 32 to display a screen. The reading control section 33 performs instructions input via the screen displayed on the reading display section 32. The reading control section 33 may control the image reading device 13 based on instructions transmitted from the control device 12.

Similar to the terminal control section 16, the reading control section 33 may be configured from one or more processors, may be configured from one or more dedicated hardware circuits, or may be configured from a circuit including a combination thereof.

The reading control section 33 is configured to analyze the image data. The reading control section 33 acquires information about the document M1 by analyzing the image data. The reading control section 33 acquires an RGB histogram or an image feature value by analyzing the image data. The reading control section 33 may recognize characters in the image by analyzing the image data. The reading control section 33 detects a specified document M1 based on the analysis result of the image data. For example, the reading control section 33 detects a blank paper document M1 based on the image data. The reading control section 33 detects a document M1 of a background color based on the image data. The reading control section 33 detects a monochrome document M1 based on the image data. The reading control section 33 detects a color document M1 based on the image data. The reading control section 33 detects a document M1 of a predetermined size based on the image data. The reading control section 33 detects a document M1 with page number based on the image data. As described above, the reading control section 33 can determine a type of document M1 based on the image data. Instead of the reading control section 33, the terminal control section 16 may analyze the image data. In this case, the reading control section 33 transmits the image data to the terminal control section 16.

The reading control section 33 detects a specified document M1 based on the number of pixels for each of RGB. The reading control section 33 detects a specified document M1 based on a ratio of luminance values in the RGB histogram. In other words, the reading control section 33 determines the type of document M1 based on relative frequency of the luminance value. For example, the reading control section 33 detects the blank paper document M1 based on the ratio of the luminance value that indicates a white color. The reading control section 33 detects the document M1 of the background color based on the ratio of the luminance value of the background color. The reading control section 33 detects the monochrome document M1 based on the ratio of the luminance value indicating a white color and the ratio of the luminance value indicating a black color. The reading control section 33 detects the color document M1 based on the ratio of luminance value indicating colors other than a white color and a black color.

Not limited to the relative frequency of the luminance value, the reading control section 33 may detect the specified documents M1 using other methods. For example, the reading control section 33 may detect the document M1 of a predetermined size using an edge extraction method. The reading control section 33 may detect the document M1 with the page number using character recognition.

The reading control section 33 is configured to be able to count documents M1. Specifically, the reading control section 33 counts documents M1 by transporting the documents M1 one by one from the batch of documents MA that were set on the supply tray 22. The reading control section 33 may count documents M1 by the count detection section 28, or may count documents M1 based on the image data. The reading control section 33 causes the display section to display the counted number of documents M1. By this, the user can grasp the number of documents M1 constituting the batch of documents MA. The reading control section 33 may cause the reading display section 32 to display the counted number of documents M1, or cause the terminal display section 15, via the terminal control section 16, to display the counted number of documents M1. Instead of the reading control section 33, the terminal control section 16 may count documents M1. The terminal control section 16 may cause the terminal display section 15 to display the counted number of documents M1.

The user may cause the image reading device 13 to count document M1 in order to create a batch of documents MA consisting of a desired number of documents M1. At this time, the user sets a batch of documents MA where documents M1 that are to be the reading target are stacked to the image reading device 13. However, there are cases where a document M1 that is not to be the reading target is mixed in the batch of documents MA. For example, there is a case where a blank paper document M1 is mixed in the batch of documents MA. There is a case where an A5-size document M1 is mixed in the batch of documents MA that consists of A4-size documents M1. There is a case where a monochrome document M1 may be mixed in a batch of documents MA that consists of color documents M1. In these cases, the user cannot correctly grasp the number of documents M1 that is to be the reading target. In this regard, the image reading device 13 is configured to be able to count documents M1 that are to be the reading target.

The reading control section 33 is configured to be able to set the target condition for the documents M1 that are to be the reading target. The target condition includes one or more conditions. In one example, the target condition includes a blank paper condition, a background color condition, a color condition, a reference condition, a size condition, a page number condition, and the like. The target condition is set via a screen displayed on the display section. In other words, the user sets the target condition via the screen displayed on the reading display section 32 or the terminal display section 15. The screen will be described later. The reading control section 33 counts the documents M1 based on the target condition.

The blank paper condition is a condition that excludes documents M1 that are blank papers. For example, the reading control section 33 determines that documents M1 that are blank papers do not match the reading target based on the blank paper condition. The reading control section 33 can count documents M1 excluding the documents M1 that are the blank papers based on the blank paper condition.

The background color condition is a condition that excludes documents M1 of background color. For example, the reading control section 33 determines that documents M1 of the background color do not match the reading target based on the background color condition. The reading control section 33 can count documents M1 excluding the documents M1 of the background color based on the background color condition. The background color condition may be a condition that excludes documents M1 of a predetermined background color. For example, the reading control section 33 detects a background color of the documents M1 based on the histogram of RGB. For example, in the histogram, the reading control section 33 sets a section that includes a luminance value with the largest number of pixels as the background section. If relative frequency of the background section is equal to or greater than a predetermined value, the reading control section 33 determines that the background section is the luminance value that indicates the background color. By this, the reading control section 33 can determine whether or not a document M1 is the document M1 of the predetermined background color. The reading control section 33 can count the documents M1 excluding the documents M1 of a predetermined background color based on the background color condition.

The color condition is a condition that excludes documents M1 that are in color or that are in monochrome. For example, the reading control section 33 determines that the color documents M1 or the monochrome documents M1 do not match the reading target based on the color condition. Based on the color condition, the reading control section 33 can count the documents M1 excluding the color documents M1 or the monochrome documents M1. The color condition may be a condition that excludes documents M1 that are in grayscale. The reading control section 33 can count the documents M1 excluding the grayscale documents M1 based on the color condition.

The reference condition is a condition that excludes documents M1 in which the number of pixels for each RGB in the image data is outside a predetermined range with respect to reference data. For example, the reading control section 33 determines, based on the reference condition, that the document M1 in which the number of pixels for each RGB is outside the predetermined range does not match the reading target. The reading control section 33 can count the documents M1 excluding the documents M1 in which the number of pixels for each of RGB are out of the predetermined range. The reading control section 33 determines whether or not the image data is similar to the reference data based on the reference condition. The reading control section 33 can count the documents M1 that were created in a common format based on the reference condition. For example, the reading control section 33 can exclude documents M1 other than computer-scored answer sheets or exclude documents M1 other than resumes based on the reference condition.

The reference condition is set based on reference data. The reference data is data that serves as a reference for the number of pixels for each of RGB. The reference data is image data of a reference document. The reference data is obtained by causing the reading section 26 to read the reference document in advance. The reading control section 33 determines whether the number of pixels of each of the RGB in the image data is within a predetermined range with respect to the number of pixels of each of the RGB in the reference data. If the number of pixels of each of RGB in the image data is within a predetermined range with respect to the number of pixels of each of RGB in the reference data, the reading control section 33 determines that the document M1 matches the reading target.

The reading control section 33 may determine the reference condition based on the number of pixels with the greatest frequency in the histogram. For example, the reading control section 33 may determine whether the number of pixels with the greatest frequency in the image data is within a predetermined range with respect to the number of pixels with the greatest frequency in the reference data. The reading control section 33 may determine whether the difference between the number of pixels is within a predetermined range.

The reading control section 33 may determine the reference condition based on a distance between a center of gravity of the reference data and a center of gravity of the image data. In this example, the reference data and the image data are represented as data of a set of points indicating the number of pixels for each of RGB. For example, the reading control section 33 may determine whether the distance between the center of gravity of the reference data and the center of gravity of the image data is within a predetermined range.

The size condition is a condition that excludes documents M1 other than a predetermined size. For example, the reading control section 33 determines that documents M1 that are not the predetermined size do not match the reading target based on the size condition. The reading control section 33 can count the document M1 excluding documents M1 that are not a predetermined size based on the size condition. In other words, the reading control section 33 can only count the documents M1 of the predetermined size. The page number condition is a condition that excludes documents M1 with no a page number. For example, the reading control section 33 determines that the documents M1 with no page number do not match the reading target based on the page number condition. The reading control section 33 can count the document M1 excluding documents M1 with no page number based on the page number condition. The page number condition may also be a condition that excludes documents M1 that do not have consecutive page numbers. For example, based on the page number condition, the reading control section 33 determines that the documents M1 whose page number are not consecutive do not match the reading target. The reading control section 33 can count the documents M1 excluding the documents M1 whose page numbers are not consecutive based on the page number condition.

The reading control section 33 counts the documents M1 that match the target condition based on the image data. The reading control section 33 causes the display section to display the number of documents M1 that match the target condition. By this, the user can correctly grasp the number of documents M1 that match the reading target.

When the reading control section 33 detects a document M1 that does not match the target condition based on the image data, the reading control section 33 causes the display section to display that the document M1 that does not match the target condition was detected. The reading control section 33 may cause the reading display section 32 to display that a document M1 that does not match the target condition was detected, or may cause the terminal display section 15 to display it via the terminal control section 16. When the terminal control section 16 detects a document M1 that does not match the target condition based on the image data, the terminal control section 16 may cause the terminal display section 15 to display that the document M1 that does not match the target conditions was detected. By this, the user can recognize that a document M1 that does not match the reading target is mixed in the batch of documents MA, a document M1 of a specific page is missing from the batch of documents MA, and the like. The user can obtain the batch of documents MA that contains only the documents M1 that are the reading target by removing a document M1 that does not match the reading target from the batch of documents MA or complementing a document M1 of a specific page to the batch of documents MA.

The reading control section 33 is configured to be capable of performing a count mode. The count mode is a mode that counts documents M1 that match the target condition. In the count mode, the reading control section 33 may count documents M1 that do not match the target condition in addition to counting the documents M1 that match the target condition. The reading control section 33 may separately count the documents M1 that match the target condition and the documents M1 that do not match the target condition.

In the count mode, the reading control section 33 counts the document M1 based on the image data. Therefore, the count mode accompanies reading by the reading section 26. Resolution of the reading section 26 in the count mode may be less than that when the reading section 26 performs normal reading. In the count mode, the reading section 26 only need to read the document M1 at a degree of resolution that allows it to determine whether or not the document M1 matches the target condition.

The count mode is performed by the user operating the operation section. The count mode may be performed by the user operating the reading operation section 31 or operating the terminal operation section 14.

In the count mode, the reading control section 33 notifies the user of the number of documents M1 that match the target condition. For example, the reading control section 33 causes the reading display section 32 or the terminal display section 15 to display the number of documents M1 that match the target condition. The count mode allows the user to grasp the number of documents M1 that match the target condition.

In the count mode, the reading control section 33 may also notify the user of the number of documents M1 that do not match the target condition. For example, the reading control section 33 may cause the reading display section 32 or the terminal display section 15 to display the number of documents M1 that do not match the target condition.

In the count mode, the reading control section 33 may suggest a recommended reading setting to the user based on an analysis result of the image data. For example, if there is a lot of monochrome image data in the counted documents M1, the reading control section 33 will suggest reading setting that makes it easier to read characters to the user. If there is a lot of image data that presents the background color in the counted documents M1, the reading control section 33 will suggest reading setting that removes the background color to the user. The reading control section 33 may cause the display section to display recommended reading setting based on the image data that was obtained in the count mode. Instead of the reading control section 33, the terminal control section 16 may suggest the recommended reading setting to the user.

The reading control section 33 may be configured to be able to perform a total count mode. The total count mode is a mode in which the document M1 is counted without referring to the target condition. In other words, the total count mode is a mode that counts all of the documents M1. In the total count mode, the reading control section 33 may count the documents M1 based on the image data, or may count the documents M1 by the count detection section 28. In other words, the total count mode may not accompany reading by the reading section 26, or it may accompany reading by the reading section 26.

The total count mode is performed by the user operating the operation section. The total count mode may be performed by the user operating the reading operation section 31 or may be performed by the user operating the terminal operation section 14.

In the total count mode, the reading control section 33 notifies the user of the counted number of documents M1. For example, the reading control section 33 causes the reading display section 32 or the terminal display section 15 to display the counted number of documents M1. The total count mode allows the user to grasp the number of documents M1 that constitute the batch of documents MA.

The reading control section 33 may be configured to be able to perform a collation mode. The collation mode is a mode in which, after the documents M1 were counted without referring to the target condition, the total number of documents M1 counted this time is collated with the total number of documents M1 counted in the total count mode. The collation mode is a mode that confirms whether other documents M1 have been mixed in the batch of documents MA, which consists of the documents M1 counted in the total count mode, or whether any documents M1 are missing from the batch of documents MA. In the collation mode, the reading control section 33 may count the documents M1 based on the image data, or may count the documents M1 by the count detection section 28. In other words, the collation mode may not accompany reading by the reading section 26, or may accompany reading by the reading section 26.

The collation mode is performed by the user operating the operation section. The collation mode may be performed by the user operating the reading operation section 31 or the terminal operation section 14.

The collation mode can be performed after the total count mode has been performed. In the collation mode, the reading control section 33 counts the documents M1 without referring to the target condition. In the collation mode, the reading control section 33 confirms whether the total number of documents M1 counted this time matches the total number of documents M1 that was counted in the total count mode. In the collation mode, the reading control section 33 notifies the user whether or not the total number of documents M1 counted this time matches the total number of documents M1 counted in the total count mode. For example, if the total number of documents M1 counted this time does not match the total number of documents M1 counted in the total count mode, the reading control section 33 will cause the reading display section 32 or the terminal display section 15 to display that fact. In other words, the reading control section 33 causes the reading display section 32 or the terminal display section 15 to display that the total number of the documents M1 counted this time does not match the total number of the documents M1 counted in the total count mode. In the collation mode, the user can grasp that unintended documents M1 are mixed in the batch of documents MA, that any documents M1 are missing from the batch of documents MA, and the like.

### Screen

Next, a screen displayed on the display section will be described. The screen described below may be displayed on the terminal display section 15 by the terminal control section 16, or may be displayed on the reading display section 32 by the reading control section 33.

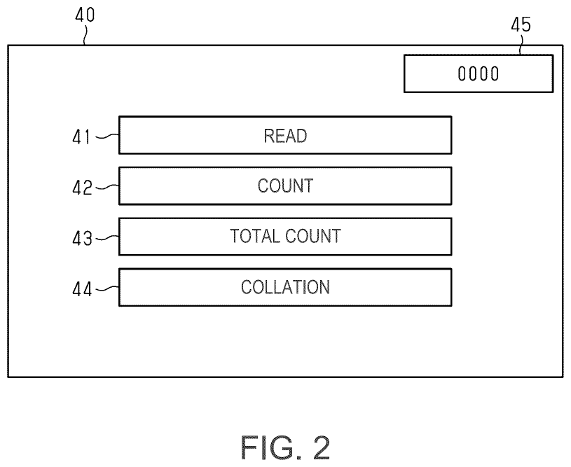

As shown in FIG. 2, a plurality of buttons are displayed on a home screen 40. For example, the home screen 40 displays a reading button 41, a count button 42, a total count button 43, a collation button 44, and the like. The reading button 41 is a button that starts reading of the document M1. The count button 42 is a button that starts the count mode. The total count button 43 is a button that starts the total count mode. The collation button 44 is a button that starts the collation mode. By operating the button, the user can cause the image reading device 13 to read the documents M1 or to perform the count mode.

The home screen 40 may also display a count field 45. The count field 45 is a field that displays the cumulative number of documents M1 counted in the count mode. By checking the count field 45, the user can grasp the number of documents M1 that has been counted through a plurality of count modes. Generally, there is an upper limit to the number of documents M1 that can be placed on the supply tray 22 of the image reading device 13. For this reason, the count field 45 is useful when the user wants to create a batch of documents MA that exceeds the maximum number of documents that can be placed on the supply tray 22. The display of the count field 45 can be reset. For example, the display of the count field 45 is reset by the user operating the operation section.

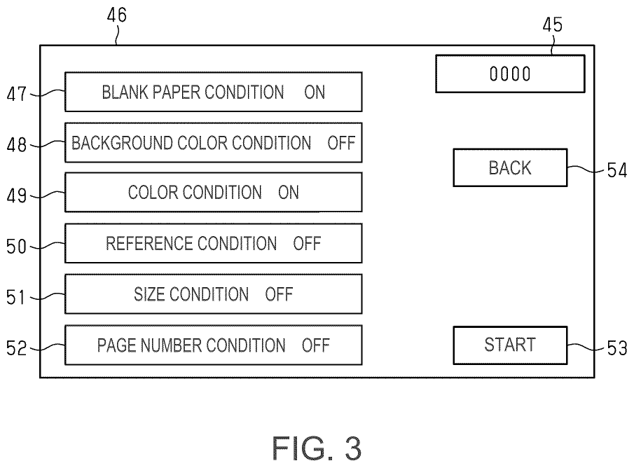

As shown in FIG. 3, when the count button 42 is operated on the home screen 40, a setting screen 46 is displayed. The setting screen 46 is a screen for setting the target condition. The setting screen 46 is a screen for setting a condition of the documents M1 to be the reading target in the count mode.

On the setting screen 46, one or more condition buttons are displayed. As an example, a blank paper condition button 47, a background color condition button 48, a color condition button 49, a reference condition button 50, a size condition button 51, and a page number condition button 52 are displayed on the setting screen 46. The condition buttons are used to set the target condition. For example, when the condition buttons are operated, the screen will change to a condition screen. The condition buttons may be labeled to indicate whether the condition is valid or invalid. In the example shown in FIG. 3, when there is an “ON” display on the condition button, it indicates that the condition of that condition button is valid.

A start button 53 is displayed on the setting screen 46. When the start button 53 is operated, counting of the documents M1 based on the target condition will start. When the start button 53 is operated, the documents M1 are counted based on the target condition set by the condition buttons.

A back button 54 may be displayed on the setting screen 46. When the back button 54 is operated, the home screen 40 is displayed. When back button 54 is operated, the target condition may be stored or may be reset. The count field 45 may be displayed on the setting screen 46.

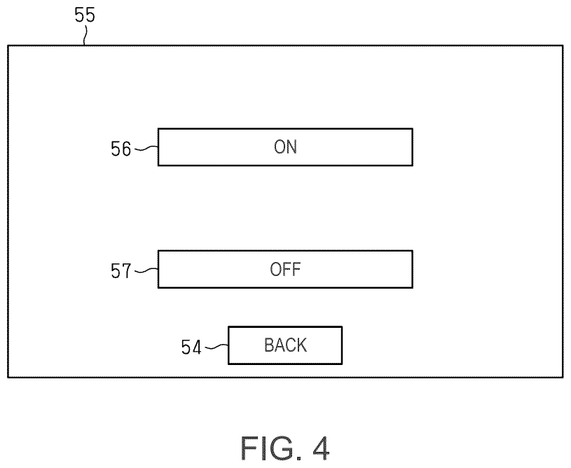

As shown in FIG. 4, when the blank paper condition button 47 is operated on the setting screen 46, a blank paper condition screen 55 is displayed. The blank paper condition screen 55 is a screen for setting a blank paper condition. The blank paper condition screen 55 is a screen for switching the validity and invalidity of the blank paper condition.

On the blank paper condition screen 55, an “ON” button 56 and an “OFF” button 57 are displayed. When the “ON” button 56 is operated, the blank paper condition will be valid. When “OFF” button 57 is operated, the blank paper condition will be invalid. On the blank paper condition screen 55, the back button 54 is displayed. When the back button 54 is operated, the screen returns to the setting screen 46.

When the background color condition button 48 is operated on the setting screen 46, a background color condition screen is displayed. The background color condition screen is a screen for setting the background color condition. In the background color condition screen, the user can specify whether or not to have the background color, or specify a predetermined background color.

When the color condition button 49 is operated on the setting screen 46, a color condition screen is displayed. The color condition screen is a screen for setting the color condition. On the color condition screen, the user can specify a color document or a monochrome document.

When the reference condition button 50 is operated on the setting screen 46, a reference condition screen is displayed. The reference condition screen is a screen for setting the reference condition. On the reference condition screen, for example, the user can specify reference data or change a threshold.

When the size condition button 51 is operated on the setting screen 46, a size condition screen is displayed. The size condition screen is a screen for setting the size condition. On the size condition screen, the user can arbitrarily specify the size of documents M1. On the size condition screen, the size of documents M1 to be the reading target may be specified. In this case, a size that is not specified is set as the size condition.

When the page number condition button 52 is operated on the setting screen 46, a page number condition screen is displayed. The page number condition screen is a screen for setting the page number condition. On the page number condition screen, the user can specify whether or not the page number was assigned. In the page number condition screen, the user may specify that the page numbers are consecutive numbers. In the page number condition screen, the user may specify the start page number and the end page number. On the page number condition screen, the user can specify a region to which the page number was assigned. If the page number condition is set to “valid”, character recognition is required, so it may take time for image analysis. Therefore, when the page number condition is valid, a message indicating that it will take time may be displayed on the page number condition screen.

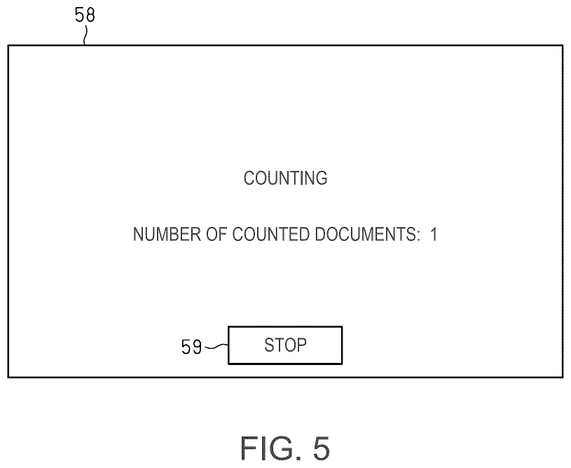

As shown in FIG. 5, when the start button 53 is operated on the setting screen 46, a current status screen 58 is displayed. The current status screen 58 is a screen that displays the number of documents that has been counted up to now. On the current status screen 58, the current number of documents M1 that match the target condition is displayed. For example, the current number of documents M1 that are not the blank papers is displayed on the current status screen 58.

A stop button 59 may be displayed on the current status screen 58. When the stop button 59 is operated, the count mode will end. By this, the user can end the count mode immediately. When stop button 59 is operated, a count result is displayed. By operating the stop button 59, the count mode may be temporarily interrupted.

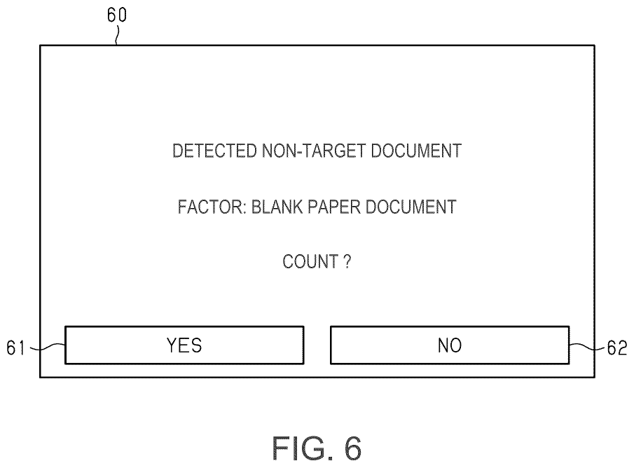

As shown in FIG. 6, if a document M1 that does not match the target condition is detected during the count mode, a notification screen 60 is displayed. The notification screen 60 is a screen for notifying that a document M1 that does not match the target condition was detected. On the notification screen 60, a message is displayed to notify that a document M1 that does not match the target condition was detected.

When a document M1 that does not match the target condition was detected, the transport section 23 is stopped and then the notification screen 60 is displayed. By this, it reduces concern that a document M1 will be transported unnecessarily.

The notification screen 60 may display a detection factor for the document M1 that was detected as not matching the target condition. In other words, the notification screen 60 may display the contents of target condition for the document M1 that was detected as not matching the target condition. For example, when a document M1 that is a blank paper was detected, a message indicating the blank paper condition may be displayed on the notification screen 60. By this, the user can grasp the detection factor of the document M1 that was detected as not matching the target condition.

The notification screen 60 is also a screen that asks the user whether or not to count the document M1 that does not match the target condition as a document M1 that matches the target condition. The notification screen 60 displays a message that asks the user whether or not to count the document M1 that does not match the target condition as a document M1 that matches the target condition.

A “YES” button 61 and a “NO” button 62 are displayed on the notification screen 60. When the “YES” button 61 is operated, the document M1 that was detected as not matching the target condition is counted as a document M1 that matches the target condition. When the “NO” button 62 is operated, the document M1 that was detected as not matching the target condition is not counted as a document M1 that matches the target condition. For example, when the “YES” button 61 or the “NO” button 62 is operated on the notification screen 60, the drive of the transport section 23 will resume. When the “YES” button 61 or the “NO” button 62 is operated on the notification screen 60, the notification screen 60 will close.

In the image reading system 11, a detection error of the document M1 may sometimes occur. For example, even though a document M1 is not a blank paper, the document M1 may be detected as a blank paper. In such a case, the user operates the “YES” button 61 on the notification screen 60. By this, even when the detection error of the documents M1 occurs, the document M1 to be the reading target can be correctly counted. Therefore, the user can grasp the number of documents M1 that match the reading target.

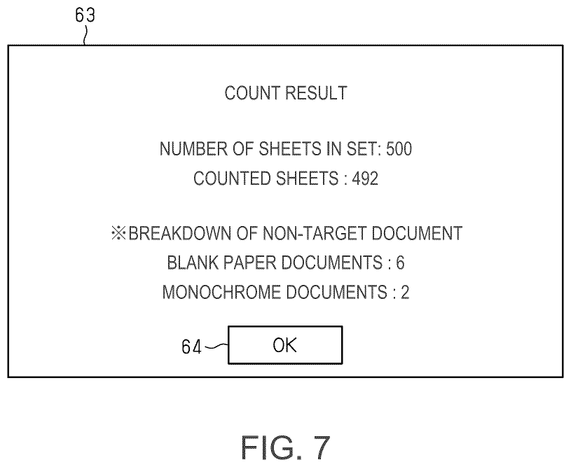

As shown in FIG. 7, when all the documents M1 have been counted, a result screen 63 is displayed. The result screen 63 may also be displayed when the stop button 59 is operated on the current status screen 58. The result screen 63 is a screen for displaying the count result. The counted number of documents M1 is displayed on the result screen 63. In other words, the result screen 63 displays the number of documents M1 that match the target condition.

The result screen 63 may also display the number of transported documents M1. The result screen 63 may display the number of documents M1, without regard to the target condition. In other words, the result screen 63 may display the total number of documents M1 that were set on the supply tray 22. The result screen 63 may display the total number of documents M1 that were detected by the count detection section 28, or may display the total number of documents M1 that were counted based on the image data. By this, the user can grasp the number of documents M1 that are not a reading target.

The result screen 63 may also display the number of documents M1 that do not match the target condition. By this, the user can intuitively grasp the number of documents M1 that do not match the target condition. The result screen 63 may also display the detection factor of the document M1 that do not match the target condition. As an example, the result screen 63 displays the number of documents M1 that were excluded based on the blank paper condition and the number of documents M1 that were excluded based on the color condition. By this, the user can grasp the detection factor of the documents M1 that do not match the target condition and the number of documents M1 thereof.

An “OK” button 64 is displayed on the result screen 63. When the “OK” button 64 is operated, the result screen 63 is closed. When the “OK” button 64 is operated, the count mode will end. When the “OK” button 64 is operated, the home screen 40 is displayed.

### Flowchart

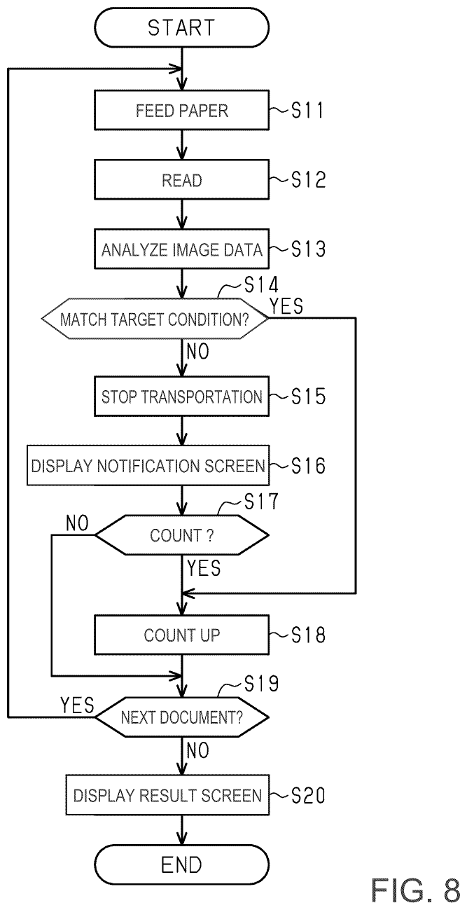

Next, the operation in the count mode will be described. The count mode may be performed solely by the reading control section 33, or it may be performed both the reading control section 33 and the terminal control section 16. Here, the reading control section 33 and the terminal control section 16 are not distinguished from each other and are simply referred to as the control section. The flowchart shown in FIG. 8 is started by operating the start button 53 on the setting screen 46. The total count mode may also be performed using the flowchart shown in FIG. 8.

As shown in FIG. 8, the control section feeds a document M1 in step S11. At this time, the control section causes the pickup roller 24 to start. In step S12, the control section reads the document M1. Specifically, the control section causes the reading section 26 to read the document M1. At this time, image data is generated.

In step S13, the control section analyzes the image data. Specifically, the control section analyzes the image data generated in step S12. In step S14, the control section determines whether the document M1 matches the target condition. Specifically, the control section determines whether or not the document M1 matches the target condition based on the image data analyzed in step S13. In other words, the control section determines whether or not the document M1 is a reading target. If document M1 matches the target condition, the control section proceeds to step S18. When the document M1 does not match the target condition, the control section proceeds to step S15.

In step S15, the control section stops transport of the document M1. At this time, the control section causes the transport section 23 to stop. In step S16, the control section causes display of the notification screen 60. At this time, the user grasps that a document M1 that does not match the target condition was detected. By looking at the notification screen 60, the user can grasp a detection factor for documents M1 that do not match the target condition.

In step S17, the control section determines whether to count the document M1 that does not match the target condition as a document M1 that matches the target condition. Specifically, the control section determines whether the “YES” button 61 is operated or the “NO” button 62 is operated on the notification screen 60. When the “YES” button 61 is operated on the notification screen 60, the control section proceeds to step S18. When the “NO” button 62 is operated on the notification screen 60, the control section proceeds to step S19. When the “NO” button 62 is operated on the notification screen 60, the control section may count up the document M1 as a document M1 that does not match the target condition.

In step S18, the control section counts up the document M1. Specifically, the control section counts up the document M1 that matches the target conditions. In step S19, the control section determines whether or not there is a next document M1. At this time, the control section determines whether or not there is a document M1 based on whether the tray detection section 27 detects the document M1. If there is a document M1 on the supply tray 22, the control section returns to step S11. If there is no document M1 on the supply tray 22, the control section proceeds to step S20.

In step S20, the control section causes to display the result screen 63. The user can grasp the number of documents M1 that match the target condition. The user can grasp the number of documents M1 that do not match the target condition. The user can grasp the detection factor for the documents M1 that do not match the target condition. When the “OK” button 64 is operated on the result screen 63, the control section ends the count mode.

As described above, the method for controlling the image reading system 11 includes counting the documents M1 that match the target condition based on the image data, and displaying the number of documents M1 that match the target condition on the display section.

### Operations and Effects of Embodiment

Next, the operation and effects of the above embodiment will be described.

(1) The control section counts the document M1 that matches the target condition based on the image data. The control section causes the display section to display the number of documents M1 that match the target condition. According to the above-described configuration, the user can correctly grasp the number of documents M1 that will be the reading target.

(2) When the control section detects a document M1 that does not match the target condition based on the image data, the control section causes the notification screen 60 to display a massage indicating that a document M1 that does not match the target condition has been detected. According to the above configuration, the user can grasp that a document M1 that is not to be the reading target, was included in the batch of documents MA.

(3) If it is selected to count the documents M1 that do not match the target condition on the notification screen 60, the control section counts the document M1 as a document that matches the target condition. In the image reading system 11, a document M1 that is to be the reading target may be determined as a document M1 that does not match the target condition. In other words, a detection error may occur in the image reading system 11. According to the above configuration, the user can correct the detection error of the image reading system 11. By this, the user can grasp the number of documents M1 that is to be the reading target.

(4) The control section counts the documents M1 based on the blank paper condition. According to the above configuration, the user can grasp the number of documents M1 excluding the blank paper documents M1.

(5) The control section counts the documents M1 based on the background color condition. According to the above configuration, the user can grasp the number of documents M1 excluding the documents M1 of predetermined background color.

(6) The control section counts the documents M1 based on the color condition. According to the above-described configuration, the user can grasp the number of documents M1 excluding the color or monochrome document M1.

(7) The control section counts the documents M1 based on the reference condition. According to the above configuration, the user can grasp the number of documents M1 excluding documents M1 that have significantly different image data from the reference data.

(8) The control section counts the documents M1 based on the size condition. According to the above configuration, the user can grasp the number of documents M1 that have a predetermined size.

(9) The control section counts the documents M1 based on the page number condition. According to the above-described configuration, the user can grasp the number of documents M1 excluding documents M1 with no page number.

(10) The detection factor for the document M1 that was detected as not matching the target condition is displayed on the notification screen 60. According to the above configuration, the user can grasp the detection factor of the documents M1 that were detected as not matching the target conditions.

(11) When the control section detects a document M1 that does not match the target condition, the control section causes the transport section 23 to stop and then causes the display section to display the notification screen 60. If it is selected to count the documents M1 that do not match the target condition on the notification screen 60, the control section counts the documents M1 as documents that match the target condition. In the image reading system 11, a document M1 that is to be the reading target may be determined as a document M1 that does not match the target condition. In other words, a detection error may occur in the image reading system 11. According to the above-described configuration, the notification screen 60 is displayed after the transport section 23 has stopped, so the user can correct the detection errors of the image reading system 11 one by one. By this, the user can grasp the number of documents M1 that is to be the reading target.

(12) According to the above configuration in which the control section causes the display section to display the number of documents M1 counted in the total count mode, the user can grasp the total number of the documents M1.

(13) In the collation mode, if the total number of documents M1 counted this time does not match the total number of documents M1 counted in the total count mode, the control section causes the display section to display that the total number of documents M1 counted this time does not match the total number of documents M1 counted in the total count mode. According to the above-described configuration, the user can grasp that the number of documents M1 does not match.

### Technical Idea

Hereinafter, technical ideas grasped from the above-described embodiments and modifications, and operations and effects thereof will be described.

(A) The image reading system includes a transport section that transports documents one by one from a batch of documents; a reading section that reads documents; a display section that displays a setting screen by which a target condition, which is a condition for a document that is to be a reading target, is set; and a control section, wherein the control section counts documents that match the target condition based on image data of the documents read by the reading section and causes the display section to display the number of documents that match the target condition. According to the above configuration, the user can correctly grasp the number of documents that is to be the reading target.

(B) The above image reading system may be configured such that if the control section detects a document that does not match the target condition based on the image data, then the control section causes display of a notification screen that indicates that a document that does not match the target condition was detected. According to the above-described configuration, the user can grasp that a document that is not to be the reading target was included in the batch of documents.

(C) The above image reading system may be configured such that the notification screen is a screen that asks whether or not to count a document that does not match the target condition as a document that matches the target condition and if it is selected on the notification screen to count the document that did not match the target condition, then the control section counts the document as a document that matches the target condition. In the image reading system, the document that is to be the reading target may be determined as a document that does not match the target condition. In other words, a detection error may occur in the image reading system. According to the above configuration, the user can correct the detection error of the image reading system. Therefore, the user can grasp the number of documents that are to be the reading target.

(D) The above image reading system may be configured such that the target condition includes a blank paper condition that excludes blank paper documents and the control section counts documents based on the blank paper condition. According to the above configuration, the user can grasp the number of documents excluding the blank paper documents.

(E) The above image reading system may be configured such that the target condition includes a background color condition that excludes documents of predetermined background color and the control section counts documents based on the background color condition. According to the above configuration, the user can grasp the number of documents excluding the documents that present the predetermined background color.

(F) The above image reading system may be configured such that the target condition includes a color condition that excludes color documents or monochrome documents and the control section counts documents based on the color condition. According to the above configuration, the user can grasp the number of documents excluding the color documents or monochrome documents.

(G) The above image reading system may be configured such that the target condition includes a reference condition that excludes documents whose number of pixels for each of RGB in the image data is outside a predetermined range with respect to reference data and the control section counts documents based on the reference condition. According to the above-described configuration, the user can grasp the number of documents excluding the documents whose image data is significantly different from the reference data.

(H) The above image reading system may be configured such that the target condition includes a size condition that excludes documents other than a predetermined size and the control section counts documents based on the size condition. According to the above configuration, the user can grasp the number of documents excluding the documents other than the predetermined size.

(I) The above image reading system may be configured such that the target condition includes a page number condition that excludes documents with no page number, and the control section counts documents based on the page number condition. According to the above configuration, the user can grasp the number of documents excluding the documents with no page number.

(J) The above image reading system may be configured such that the notification screen displays a detection factor for the document that was detected as not matching the target condition. According to the above configuration, the user can grasp the detection factor for the documents that were detected as not matching the target condition.

(K) The above image reading system may be configured such that the notification screen is a screen that asks whether or not to count a document that does not match the target condition as a document that matches the target condition and when the control section detects a document that does not match the target condition, the control section causes the transport section to stop and then causes the display section to display the notification screen, and if it is selected on the notification screen to count the document that did not match the target condition, then the control section counts the document as a document that matches the target condition. In the image reading system, the document that is to be the reading target may be determined as a document that does not match the target condition. In other words, a detection error may occur in the image reading system. According to the above configuration, the notification screen is displayed after the transport section has been stopped, so the user can correct the detection error of the image reading system one by one. Therefore, the user can grasp the number of documents that are to be the reading target.

(L) The above image reading system may be configured such that in a total count mode that counts documents without referring to the target condition, the control section causes the display section to display the number of counted documents. According to the above configuration, the user can grasp the total number of documents.

(M) The above image reading system may be configured such that after counting documents without referring to the target condition, in a collation mode where the total number of documents counted this time is collated with the total number of documents counted in the total count mode, if the total number of documents counted this time is not the same as the total number of documents counted in the total count mode, then the control section causes the display section to display that the total number of documents counted this time is not the same as the total number of documents counted in the total count mode. According to the above configuration, the user can recognize that the number of documents does not match.

(N) The image reading device includes a transport section that transports documents one by one from a batch of documents; a reading section that reads documents; a display section that displays a setting screen by which a target condition, which is a condition for a document that is to be a reading target, is set; and a control section, wherein the control section counts documents that match the target condition based on image data of the documents read by the reading section and causes the display section to display the number of documents that match the target condition. According to the above configuration, the same effects as those of the image reading system described above can be obtained.

(O) A control device connected to an image reading device that includes a transport section that transports documents one by one from a batch of documents and a reading section that reads documents, the control device includes a display section that displays a setting screen by which a target condition, which is a condition for a document that is to be a reading target, is set; and a control section configured to communicate with the image reading device, wherein the control section counts documents that match the target condition based on image data of the documents read by the reading section and causes the display section to display the number of documents that match the target condition. According to the above configuration, the same effects as those of the image reading system described above can be obtained.

(P) A method for controlling an image reading system that includes a transport section that transports documents one by one from a batch of documents, a reading section that reads documents, and a display section that displays a setting screen for setting a target condition for the documents to be a reading target, the method for the image reading system includes counting a document that matches the target condition based on image data of the document read by the reading section and causing the display section to display the number of documents that match the target condition. According to the above method, the same effects as those of the image reading system described above can be obtained.

What is claimed is:

1. An image reading system comprising:
a transport section that transports documents one by one from a batch of documents;
a reading section that reads documents;
a display section that displays a setting screen by which a target condition, which is a condition for a document that is to be a reading target, is set; and
a control section, wherein
the control section
counts documents that match the target condition based on image data of the documents read by the reading section and
causes the display section to display the number of documents that match the target condition.

2. The image reading system according to claim 1, wherein
if the control section detects a document that does not match the target condition based on the image data, then the control section causes display of a notification screen that indicates that a document that does not match the target condition was detected.

3. The image reading system according to claim 2, wherein
the notification screen is a screen that asks whether or not to count a document that does not match the target condition as a document that matches the target condition and
if it is selected on the notification screen to count the document that did not match the target condition, then the control section counts the document as a document that matches the target condition.

4. The image reading system according to claim 1, wherein
the target condition includes a blank paper condition that excludes blank paper documents and
the control section counts documents based on the blank paper condition.

5. The image reading system according to claim 1, wherein
the target condition includes a background color condition that excludes documents of predetermined background color and
the control section counts documents based on the background color condition.

6. The image reading system according to claim 1, wherein
the target condition includes a color condition that excludes color documents or monochrome documents and
the control section counts documents based on the color condition.

7. The image reading system according to claim 1, wherein
the target condition includes a reference condition that excludes documents whose number of pixels for each of RGB in the image data is outside a predetermined range with respect to reference data and
the control section counts documents based on the reference condition.

8. The image reading system according to claim 1, wherein
the target condition includes a size condition that excludes documents other than a predetermined size and
the control section counts documents based on the size condition.

9. The image reading system according to claim 1, wherein
the target condition includes a page number condition that excludes documents with no page number and
the control section counts documents based on the page number condition.

10. The image reading system according to claim 2, wherein
the notification screen displays a detection factor for the document that was detected as not matching the target condition.

11. The image reading system according to claim 2, wherein
the notification screen is a screen that asks whether or not to count a document that does not match the target condition as a document that matches the target condition,
when the control section detects a document that does not match the target condition, the control section causes the transport section to stop and then causes the display section to display the notification screen, and
if it is selected on the notification screen to count the document that did not match the target condition, then the control section counts the document as a document that matches the target condition.

12. The image reading system according to claim 1, wherein
in a total count mode that counts documents without referring to the target condition, the control section causes the display section to display the number of counted documents.

13. The image reading system according to claim 12, wherein
after counting documents without referring to the target condition, in a collation mode where the total number of documents counted this time is collated with the total number of documents counted in the total count mode, if the total number of documents counted this time is not the same as the total number of documents counted in the total count mode, then the control section causes the display section to display that the total number of documents counted this time is not the same as the total number of documents counted in the total count mode.

14. An image reading device comprising:
a transport section that transports documents one by one from a batch of documents;
a reading section that reads documents;
a display section that displays a setting screen by which a target condition, which is a condition for a document that is to be a reading target, is set; and
a control section, wherein
the control section
counts documents that match the target condition based on image data of the documents read by the reading section and
causes the display section to display the number of documents that match the target condition.

15. A control device connected to an image reading device that includes a transport section that transports documents one by one from a batch of documents and a reading section that reads documents, the control device comprising:
a display section that displays a setting screen by which a target condition, which is a condition for a document that is to be a reading target, is set and
a control section configured to communicate with the image reading device, wherein
the control section
counts documents that match the target condition based on image data of the documents read by the reading section and
causes the display section to display the number of documents that match the target condition.
